(19) United States
(12) Patent Application Publication
(10) Pub. No.: US 2004/0015612 A1
(43) Pub. Date: Jan. 22, 2004

(54) Method for producing chips, especially for sim cards, in a series

(76) Inventor: Sven Gossel, Munchen (DE)

Correspondence Address: Clark & Brody, Suite 600, 1750 K Street NW, Washington, DC, 20006, US

(21) Appl. No.: 10/363,630

(22) PCT Filed: Aug. 18, 2001
(86) PCT No.: PCT/EP01/09550

(30) Foreign Application Priority Data
Sep. 5, 2000 (EP) 001191626
Sep. 5, 2000 (EP) 001191634
Oct. 4, 2000 (EP) 001216365

(51) Int. Cl. H04M 1/66; G06F 3/00

(52) U.S. Cl. 710/1; 455/410

(57) ABSTRACT

A method and apparatus for producing chips, especially for SIM cards, in a series, comprises the steps of creating software, disposing the software on a chip, and applying personalization data relating to the chip carrier and a user. The personalization data is applied to the chip first, and the personal user data is applied separately from the personal data relating to the chip carrier in a later production step.

The present invention concerns a method for series production of chips, in particular for SIM cards, that comprises the following steps:

a software program is created;

the software program is applied onto a chip;

chip-carrier-related and user-related personalization data are applied onto the chip.

The invention is concerned with the production of all types of chips, and principally with the production of so-called SIM (subscriber identity module) cards, i.e. mobile radio cards that are inserted into a mobile telephone and must be activated by entering a PIN so that the mobile telephone can be used to place or accept calls. A chip on the SIM card stores the information needed by the mobile telephone in order to log into a mobile radio network after being switched on. The data that must be stored on the chip for this purpose are called personalization data; a distinction is made between chip-carrier-related personalization data that are identical for all chip carriers of a type for which the chips are intended (for example wristwatches, cards, etc.), and user-related personalization data that individualize the card (for example, serial number, PIN number, etc.).

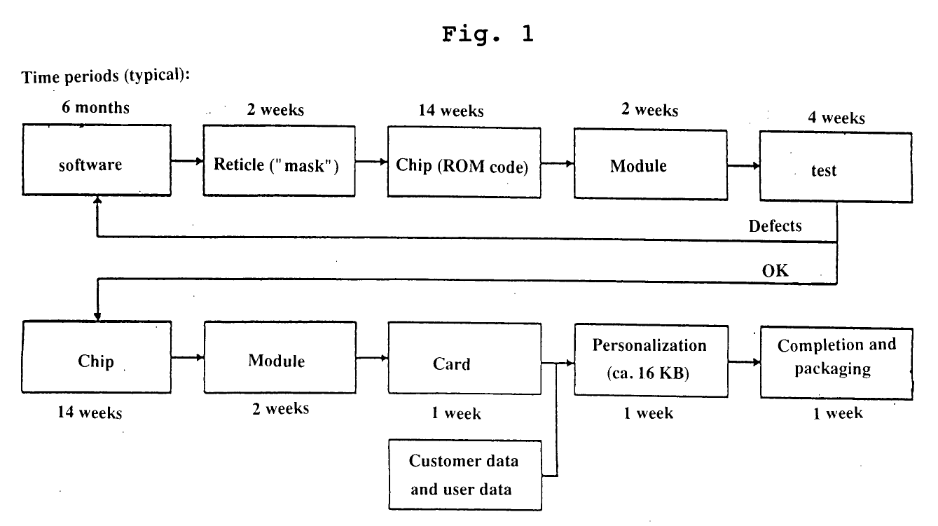

SIM cards are at present usually produced in the manner schematically depicted in FIG. 1 and described below:

The first step is software development, which requires a period of approximately 6 months. Based on this software, a mask is created, and on the basis of that in turn a ROM chip is produced. This requires approximately 16 weeks. The chip is then embedded into a module and tested (approx. 6 weeks). If defects occur, the software is modified and the process of mask creation, chip production, module production, testing, and modification is repeated until the test results are OK. Only then does series production begin, in which first the ROM chip is produced and embedded into a module, which takes approximately 16 weeks. Then plastic cards are produced and (if applicable) imprinted, and the chip modules are embedded into the cards. The personalization data are then applied onto the chips.

The process described above is very laborious and results on the one hand in considerable delivery times and on the other hand in considerable production costs.

It is therefore the object of the invention to develop a method for series production of chips of the kind cited initially in such a way that production times and production costs can be decreased.

This object is achieved, according to the present invention, in that first the chip-carrier-related personalization data are applied onto the chips, and the user-related personalization data are applied onto the chips only in a later production step, separately from the chip-carrier-related personalization data. The underlying idea of the invention is thus not to perform personalization of the chips in one production step as in the existing art, but rather first to apply the customer-specific (i.e. chip-carrier-related) personalization data onto the chip in the context of a pre-personalization process, and later to perform a post-personalization in the context of which the user-related personalization date (for example the key number and ID numbers) are then applied onto the cards. This separation of pre- and post-personalization results in a considerable lowering of production costs. The reason for this is that the user-related personalizaiton data are security-relevant data that must be applied onto the chip only in correspondingly secure environments. Whereas in the existing art all the personalization data are applied simultaneously onto the chips in a secure environment (which requires a programming time of approximately one minute), as a result of the division of the personalization process effected according to the present invention, the chips need to be in a secure environment only for the time necessary to apply the user-related personalization data onto a chip. This amounts to only a few seconds, however, so that capital costs for secure environments and monitoring actions are low.

According to a preferred embodiment, provision is made for the chip-carrier-related personalization data to be applied onto the card in one production step along with chip module production. The consideration underlying this embodiment is that immediately after its production, the chip modules must be tested by a testing device as to their functionality; this usually requires approximately 4 to 5 seconds. It is precisely this time that is used, according to the present invention, to perform pre-personalization. By way of a corresponding number of programming heads, it is possible to ensure that pre-personalization, which takes approximately 20 to 80 seconds, does not slow down module production and inspection. The time for personalization in a separate production step can thereby be considerably decreased. This also contributes to a lowering of production costs.

Application of the pre-personalization data can be performed in the context of module production by a separate apparatus tat has a corresponding number of more than 16 programming heads. Similarly, the testing device for testing the chips can also be equipped with that number of programming heads.

Alternatively, it is possible to provide the pre-personalization data already in an earlier production step, for example during production of the wafers from which the chips are ultimately created, or of the chips. The wafers are usually also subjected to a functionality test, so that the testing time necessary here would also be available for pre-personalization without slowing down the process. A separate apparatus can again be provided for pre-personalization, or the testing device for the wafers can be equipped with a corresponding number of at least 16 programming heads.

Ultimately, however, it is immaterial whether personalization is performed in a separate production step or is incorporated into an existing production step. What is essential is that pre-personalization is accomplished separately from post-personalization; pre-personalization can certainly also be accomplished in multiple steps or levels.

Post-personalization can also be performed by a separate programming apparatus having at least one corresponding programming head. According to a preferred embodiment, however, provision is made for the user-related personalization data to be applied onto the chip in the production step of automatically embedding the chip modules into a carrier, for example a card or the cards. This in-line application of the user-related personalization data during the module embedding process allows production times to be decreased further, since these data no longer need to be introduced in a separate production step.

According to a further aspect of the present invention, flash controllers are used for the chips instead of the ROMs heretofore utilized. It is thereby possible to eliminate development batches such as those of the existing art, and to circumvent tedious chip production runs. With a corresponding software platform that shortens the process of porting software onto other semiconductors (hardware abstraction layer), that software can then be used immediately in conjunction with the flash controllers. Tedious development and testing time is therefore eliminated or can be greatly abbreviated.

Regarding further advantageous embodiments of the invention, reference is made to the dependent claims and to the description below of an exemplary embodiment that refers to the appended drawings, in which:

FIG. 1 shows a flow chart depicting the development and production of chip cards according to the existing art; and

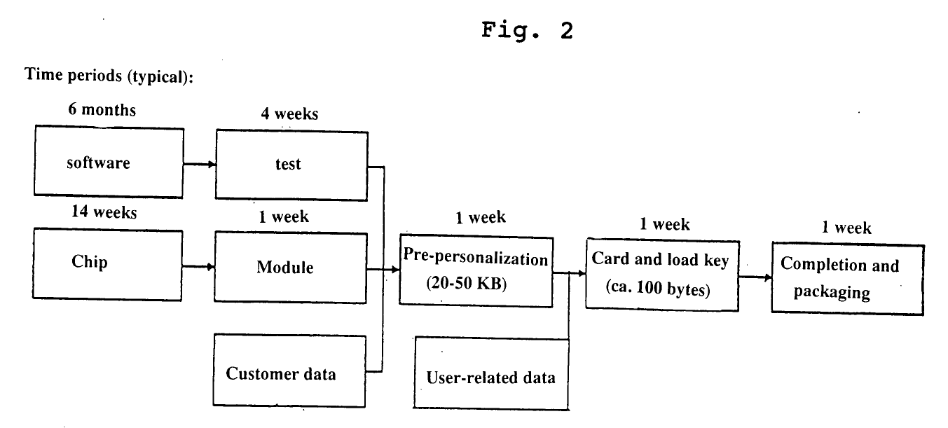

FIG. 2 shows a flow chart depicting the method for series production of chip cards according to the present invention.

In the method depicted in FIG. 2 for series production of chip cards according to the present invention, what occurs first is development of a corresponding software program, which—as in the existing art—takes approximately 6 months. This software program is configured such that it shortens the process of porting to other semiconductors to a minimum of time and cost (hardware abstraction layer), and is usable in conjunction with flash controllers. Concurrently with this software development, the flash controller chips are produced. The chips are then embedded into modules in the usual way and with corresponding machines, and then programmed with the software that was developed. The chip modules programmed in this fashion are transported, for example by way of conveyor belts, to a testing device, and there tested as to their functionality. This testing mode is known per se and thus will not be described in further detail at this juncture. All that is of interest is that a testing time of 20 to 80 seconds is necessary for each chip, for which reason several chips are tested simultaneously in each case so as not to slow down the process of module production and programming.

Subsequent to the functionality inspection, the prepersonalization data (i.e. the card-related personalization data) are applied onto the functional chip modules, for which purpose the testing device is equipped with a total of more than 16 programming heads, to which the chip modules are automatically transported. Since pre-personalization takes more time than the previously performed functionality test, parallel programming of several chips is performed, for which purpose a corresponding number of programming heads are provided.

The chip modules that have been completed and programmed with pre-personalization data in this fashion are then embedded in the usual way into plastic cards. Prefabricated plastic blanks having a corresponding cavity and plug-in form are preferably used for this purpose. Application of the user-related personalization data onto the chips by a corresponding programming apparatus is accomplished prior or subsequent to embedding, but in the same production step. This personalization step, which represents the only security-relevant step in production (since it is only here that the code and ID number are entered), is performed in a secure environment. Since only a few seconds are necessary for this part of the personalization process, the capital costs for secure environments can be minimized.

It has been found that production times and costs can be considerably decreased by applying the method according to the present invention, i.e. the use of flash controllers instead of ROMs, pre-personalization in the context of module production, and application of user-related personalization data during the embedding of modules into the cards.

1. A method for series production of chips, in particular for SIM cards, that comprises the following steps:
a software program is created;
the software program is applied onto a chip;
chip-carrier-related and user-related personalization data are applied onto the chip,
the method being characterized in that first the chip-carrier-related personalization data are applied onto the chips, and the user-related personalization data are applied onto the chips only in a later production step, separately from the chip-carrier-related personalization data.

2. The method as defined in claim 1, characterized in that the chip-carrier-related personalization data are applied onto the chips in multiple steps.

3. The method as defined in claim 1 or 2, characterized in that the chip-carrier-related personalization data are applied onto the chips in one production step along with chip module production.

4. The method as defined in claim 3, characterized in that the chip modules are tested by a testing device as to their functionality, and the system-related personalization data are applied onto the chips in the context of this testing operation.

5. The method as defined in claim 1, characterized in that application of the software is accomplished in one production step along with chip module production.

6. The method as defined in claim 1, characterized in that the chip-carrier-related personalization data are applied onto wafers from which the chips are produced.

7. The method as defined in claim 6, characterized in that the wafers are tested as to their functionality, and the chip-carrier-related personalization data are applied onto the wafers during that test.

8. The method as defined in one of the foregoing claims, characterized in that flash controllers are used for the chips.

9. The method as defined in one of the foregoing claims, characterized in that the chip modules are each embedded into a carrier, in particular into a card, and the user-related personalization data are applied onto the chip in the production step of automatically embedding the chip modules into the carriers.

10. The method as defined in claim 9, characterized in that prefabricated cards, having a cavity for the chip modules that are to be embedded, are used as carriers.

11. The method as defined in claim 10, characterized in that prefabricated cards, having a cavity and plug-in form for the chips that are to be embedded, are used.

12. An apparatus for testing wafers, characterized in that it has more than 16 programming heads in order to apply chip-carrier-related personalization data onto the chips.

13. An apparatus for testing chips or cut wafers as to their functionality, characterized in that it has more than 16 and, in particular, 32 programming heads in order to apply chip-carrier-related personalization data onto the chips.

14. An apparatus for producing chip modules, characterized in that it has more than 16 programming heads in order to apply chip-carrier-related personalization data onto the chips.

15. An apparatus for testing chip modules, characterized in that it has more than 16 programming heads in order to apply chip-carrier-related personalization data onto the chips.

16. An apparatus for embedding chip modules into an, in particular, card-shaped carrier, characterized in that it has at least one programming head in order to apply user-related personalization data onto the chips of the chip modules.

17. An apparatus for personalizing chips embedded into a carrier, characterized in that is has at least one programming head for applying user-related personalization data.
